(19) United States
(12) Patent Application Publication
(10) Pub. No.: US 2015/0061433 A1
(43) Pub. Date: Mar. 5, 2015

(54) ELECTRICITY COLLECTION AND DISTRIBUTION RING

(71) Applicant: HITACHI METALS, LTD., Tokyo (JP)

(72) Inventor: Kenichi EGAMI, Kitaibaraki (JP)

(73) Assignee: HITACHI METALS, LTD., Tokyo (JP)

(21) Appl. No.: 14/469,927

(22) Filed: Aug. 27, 2014

(30) Foreign Application Priority Data
Aug. 27, 2013 (JP) 2013-175264

(51) Int. Cl. H02K 3/50; H02K 3/28

(52) U.S. Cl. CPC H02K 3/50; H02K 3/28
USPC 310/71

(57) ABSTRACT

An electricity collection and distribution ring for collecting and distributing electricity from/to multi-phase windings includes a plurality of annular conductors respectively connected to the multi-phase windings according to the phases of electric current, and a plurality of fixing members for fixing the plurality of annular conductors to each other. The annular conductor includes a plurality of connecting portions connected to end portions of the windings at a plurality of positions in a circumferential direction. The fixing members are disposed between a pair of the plurality of connecting portions adjacent along a circumferential direction of the plurality of annular conductors.

The present application is based on Japanese patent application No. 2013-175264 filed on Aug. 27, 2013, the entire contents of which are incorporated herein by reference.

### BACKGROUND OF THE INVENTION

1. Field of the Invention

The invention relates to an electricity collection and distribution ring for collecting and distributing electricity from/to multi-phase windings.

2. Description of the Related Art

An electricity collection and distribution ring is known that supplies motor current to U-, V- and W-phase wirings of a three-phase AC motor (see JP-B-3902219).

The electricity collection and distribution ring (or centralized power distribution member) disclosed in JP-B-3902219 has four annular conductors each formed in an annular shape and respectively corresponding to U-, V-, W- and neutral phases, plural holding members for fixing the four annular conductors to each other in an axially-aligned state, and plural junction terminals for connecting each annular conductor to the windings.

Each holding member has first and second housing grooves which open respectively at both ends in the axial direction of the holding member. Some of the plural annular conductors are held in the first housing groove and the remaining annular conductors are held in the second groove. In addition, an attachment groove for connecting the junction terminal to the annular conductor is formed on the holding member. The position of the attachment groove differs depending on the axial position of the annular conductor to which the junction terminal is connected. That is, in this electricity collection and distribution ring, the bus rings are electrically and mechanically connected to the windings by the junction terminals and several types of holding members having the attachment groove at a different position.

### SUMMARY OF THE INVENTION

The fixing member disclosed in JP-B-3902219 requires several types of molds to mold the holding members since several types of holding members having the attachment groove at a different position are used and it is thus difficult to reduce the cost. In addition, rigidity of holding the annular conductors may be reduced since the attachment groove for attaching the junction terminal is formed on the holding member.

It is an object of the invention to provide an electricity collection and distribution ring that needs no attachment grooves for attaching terminals so as to allow the reduced cost and the improved rigidity thereof.
(1) According to one embodiment of the invention, an electricity collection and distribution ring comprises:
   a plurality of annular conductors respectively connected to the multi-phase windings according to the phases of electric current; and
   a plurality of fixing members for fixing the plurality of annular conductors to each other,
   wherein the annular conductor comprises a plurality of connecting portions connected to end portions of the windings at a plurality of positions in a circumferential direction, and
   wherein the plurality of fixing members are disposed between a pair of the plurality of connecting portions adjacent along a circumferential direction of the plurality of annular conductors.

### Effects of the invention

According to one embodiment of the invention, an electricity collection and distribution ring can be provided that that needs no attachment grooves for attaching terminals so as to allow the reduced cost and the improved rigidity thereof.

### BRIEF DESCRIPTION OF THE DRAWINGS

Next, the present invention will be explained in more detail in conjunction with appended drawings, wherein:

FIG. 1 is an explanatory schematic diagram illustrating a rough configuration example of an electric motor which is provided with an electricity collection and distribution ring in a first embodiment of the present embodiment;

FIG. 2 is an appearance diagram illustrating a configuration example of the electricity collection and distribution ring in the first embodiment of the invention;

FIG. 3 is an appearance diagram illustrating a state in which the electricity collection and distribution ring in the first embodiment of the invention is mounted on a stator;

FIG. 4 is a plan view showing the stator and first to third bus rings as viewed from a central axis direction thereof;

FIG. 5 is a perspective view showing the first to third bus ring;

FIG. 6A shows a connecting portion of the first bus ring, FIG. 6B shows a connecting portion of the second bus ring and FIG. 6C shows a connecting portion of the third bus ring;

FIG. 7A is a perspective view showing an appearance of a fixing member, FIG. 7B is a side view showing the fixing member and FIG. 7C is a top view showing the fixing member;

FIG. 8A is a plan view showing a portion of the electricity collection and distribution ring as viewed from an axial direction thereof in a state that the fixing members are detached and FIG. 8B is a diagram illustrating a state in which the fixing members are attached to the electricity collection and distribution ring of FIG. 8A;

FIG. 9 is a side view showing a fixing member in a second embodiment of a invention; and

FIG. 10 is an appearance diagram illustrating a configuration example of the electricity collection and distribution ring in a third embodiment of the invention.

### DETAILED DESCRIPTION OF THE PREFERRED EMBODIMENTS

### First Embodiment

### General Configuration of Electric Motor

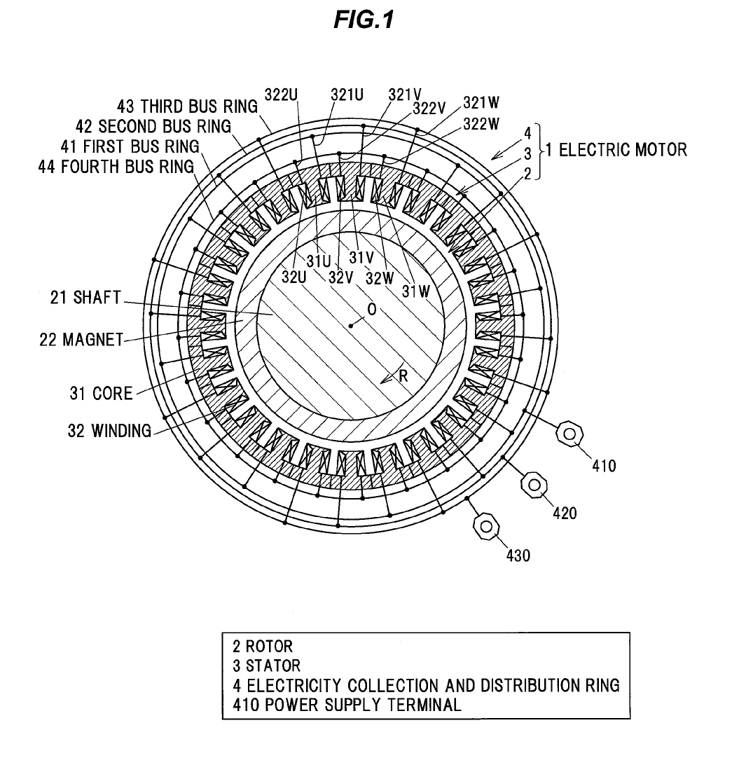

FIG. 1 is a schematic diagram of an electric motor 1 for explaining a function of an electricity collection and distribution ring 4 in the first embodiment of the invention.

The electric motor 1 is provided with a rotor 2, a stator 3 and the electricity collection and distribution ring 4 composed of first to fourth bus rings 41 to 44.

The rotor 2 has a shaft 21 and a cylindrical magnet 22. The shaft 21 is rotatably supported by a non-illustrated bearing and is located coaxially with the stator 3. The magnet 22 is fixed to an outer peripheral surface of the shaft 21 and has plural magnetic poles.

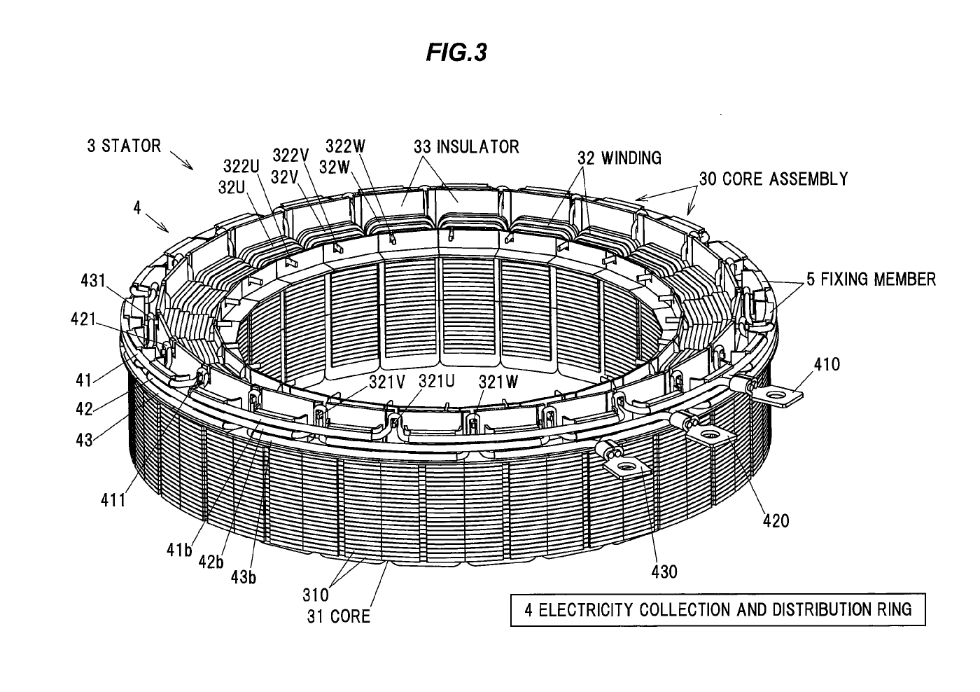

The stator 3 is provided with multi-phase windings 32 respectively wound around outer peripheries of plural annularly-arranged cores 31, and insulators 33 described later (shown in FIG. 3). In the first embodiment, twenty-four cores 31 are arranged along a circumferential direction of the stator 3. The twenty-four cores 31 are categorized into U-phase cores 31U, V-phase cores 31V and W-phase cores 31W according to the positions thereof and are arranged such that the V-phase core 31V is next to the U-phase core 31U, the W-phase core 31W next to the V-phase core 31V and the U-phase core 31U next to the W-phase core 31W along a rotational direction R of the rotor 2 shown in FIG. 1.

The windings 32 wound around the U-phase cores 31U are U-phase windings 32U, the windings 32 wound around the V-phase cores 31V are V-phase windings 32V and the windings 32 wound around the W-phase cores 31W are W-phase windings 32W. The U-phase windings 32U collect and distribute electricity (power collection and power distribution) via the first bus ring 41. The V-phase windings 32V collect and distribute electricity via the second bus ring 42. The W-phase windings 32W collect and distribute electricity via the third bus ring 43.

An end portion 321U, which is one of both end portions of the U-phase winding 32U, is electrically connected to the first bus ring 41 and another end portion 322U is electrically connected to the fourth bus ring 44. An end portion 321V, which is one of both end portions of the V-phase winding 32V, is electrically connected to the second bus ring 42 and another end portion 322V is electrically connected to the fourth bus ring 44. In addition, an end portion 321W, which is one of both end portions of the W-phase winding 32W, is electrically connected to the third bus ring 43 and another end portion 322W is electrically connected to the fourth bus ring 44.

The first bus ring 41 is one aspect of a first annular conductor of the invention and the second bus ring 42 is one aspect of a second annular conductor of the invention. In addition, the third bus ring 43 is one aspect of a third annular conductor of the invention. The fourth bus ring 44 serves as a neutral-phase bus ring.

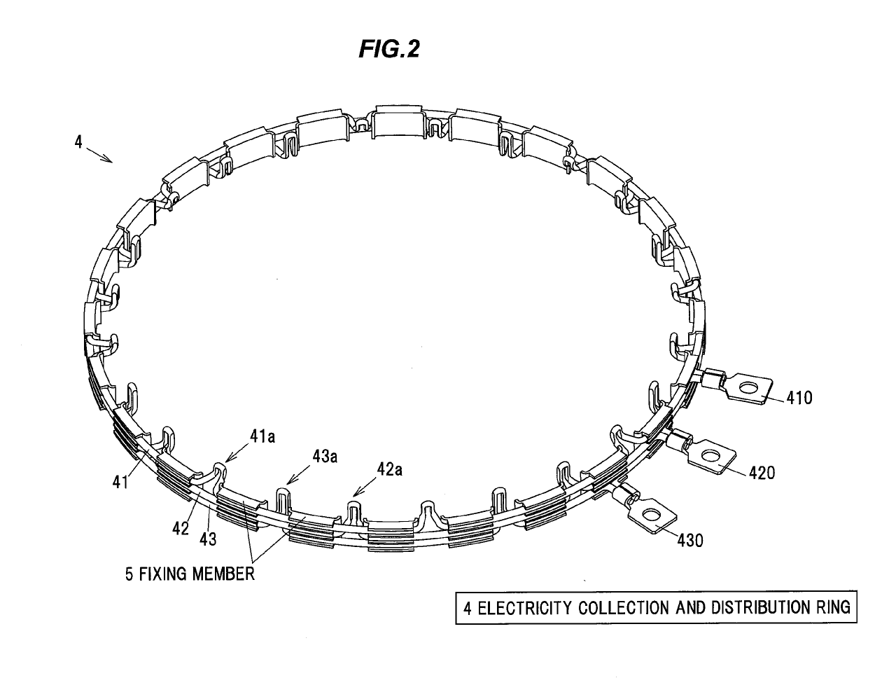

Power supply terminals 410, 420 and 430 are respectively connected to the first to third bus rings 41 to 43. Drive currents having sine waveforms 120 degrees out of phase with each other are supplied from a non-illustrated inverter via the power supply terminals 410, 420 and 430. A rotating magnetic field is created in the stator 3 by the drive currents, the magnet 22 receives a torque generated by an attractive force and a repulsive force caused by the rotating magnetic field and thus rotates the shaft 21. The first to third bus rings 41 to 43 are fixed to each other by below-described fixing members 5 (shown in FIG. 2).

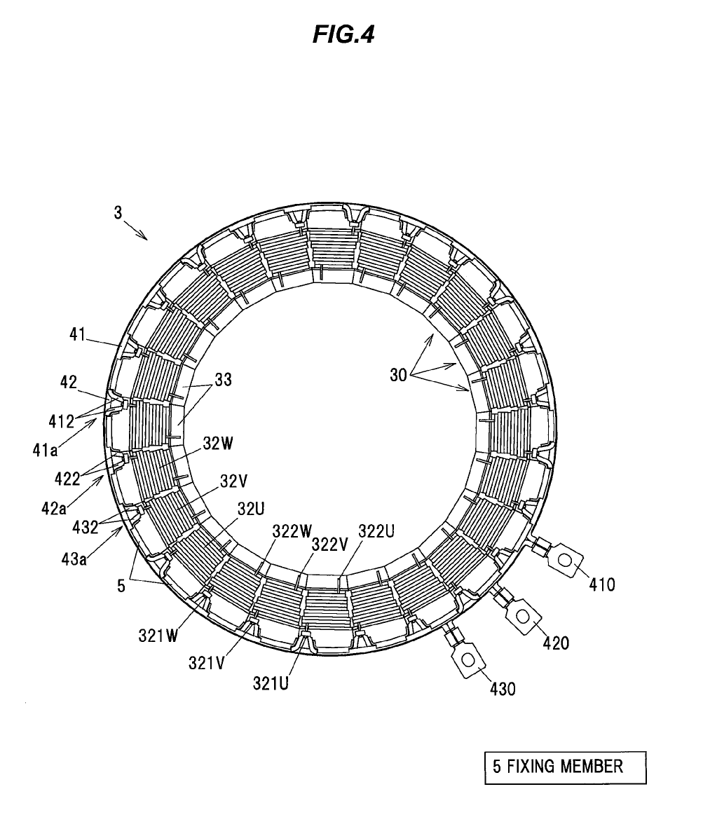

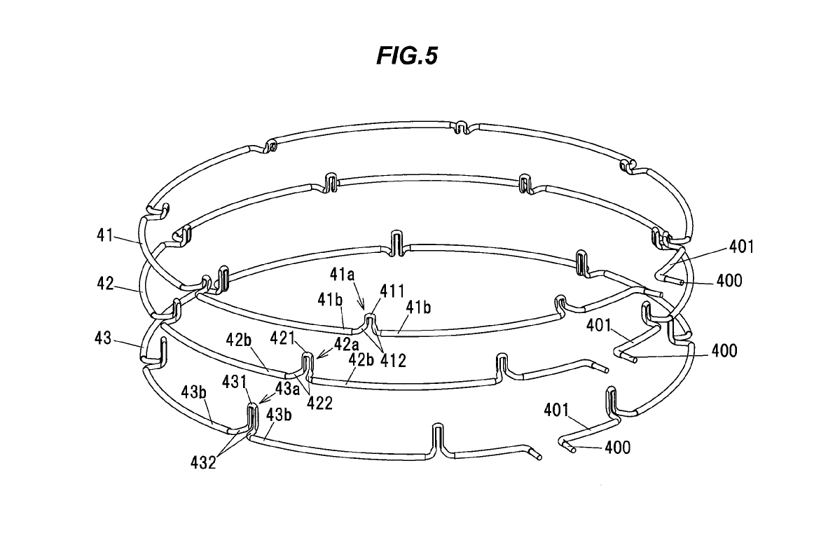

FIG. 2 is a perspective view showing an appearance of the electricity collection and distribution ring 4 in the first embodiment. FIG. 3 is a perspective view showing a state in which the electricity collection and distribution ring 4 is mounted on the stator 3. FIG. 4 is a plan view showing the stator 3 shown in FIG. 3 and the first to third bus rings 41 to 43 as viewed from a central axis direction thereof. FIG. 5 is a perspective view showing the first to third bus rings 41 to 43. An axial direction, a radial direction and a circumferential direction of the first to third bus rings 41 to 43 are sometimes simply mentioned as “the axial direction”, “the radial direction” and “the circumferential direction” in the following description.

The electricity collection and distribution ring 4 is provided with the first to third bus rings 41 to 43 respectively connected to the multi-phase (U-, V- and W-phase) windings 32U, 32V and 32W according to the phases of electric current, and plural fixing members 5 (twenty-four, in the first embodiment) for fixing the first to third bus rings 41 to 43 to each other.

In the first bus ring 41, connecting portions 41a for connection to the end portions 321U of the U-phase windings 32U are provided at plural circumferential positions and each supported portion 41b located between a pair of adjacent connecting portions 41a is held by the fixing members 5. In the second bus ring 42, connecting portions 42a for connection to the end portions 321V of the V-phase windings 32V are provided at plural circumferential positions and each supported portion 42b located between a pair of adjacent connecting portions 42a is held by the fixing members 5. In the third bus ring 43, connecting portions 43a for connection to the end portions 321W of the W-phase windings 32W are provided at plural circumferential positions and each supported portion 43b located between a pair of adjacent connecting portions 43a is held by the fixing members 5.

In the first embodiment, the connecting portions 41a, 42a, 43a of eight each are respectively provided on the first to third bus rings 41 to 43 at equal intervals. In addition, the first to third bus rings 41 to 43 are fixed to the fixing members 5 in a state of being concentrically aligned along the axial direction. The detailed configuration of the fixing member 5 will be described later.

The stator 3 is composed of plural core assemblies 30 in each of which the insulator 33 is attached to the core 31 formed by laminating plural electromagnetic steel sheets 310 and the winding 32 is wound around the outer periphery of the core 31 with the insulator 33 interposed therebetween. In the first embodiment, the stator 3 has a ring shape formed by annularly arranging twenty-four core assemblies 30.

Meanwhile, the electricity collection and distribution ring 4 is arranged on the outer peripheral side of the stator 3 with respect to the windings 32 (32U, 32V, 32W) and the end portions 321U, 321V and 321W of the windings 32 extending outward in the radial direction are respectively connected to the connecting portions 41a, 42a and 43a of the first to third bus rings 41 to 43. The other end portions 322U, 322V and 322W of the windings 32 extending inward in the radial direction are connected to the fourth bus ring 44 (shown in FIG. 1).

### Configuration of First to Third Bus Rings 41 to 43

As shown in FIG. 5, each of the first to third bus rings 41 to 43 is formed by bending an insulated wire in which a center conductor (metal conductor) 400 formed of a highly conductive such as copper is covered with a resin insulation 401. The center conductor 400 is exposed from the insulation 401 at both ends of each of the first to third bus rings 41 to 43 and the power supply terminal 410, 420 or 430 is connected to the exposed center conductor 400 by pressure bonding or crimping.

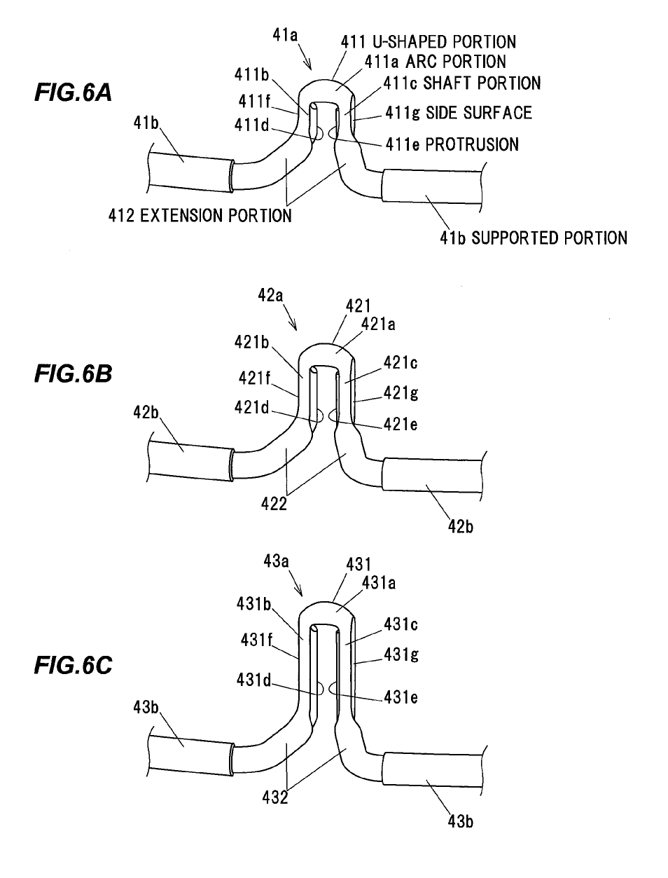

FIG. 6A shows the connecting portion 41a and the supported portion 41b of the first bus ring 41, FIG. 6B shows the connecting portion 42a and the supported portion 42b of the second bus ring 42 and FIG. 6C shows the connecting portion 43a and the supported portion 43b of the third bus ring 43.

The connecting portion 41a integrally has a U-shaped portion 411 formed by bending the center conductor 400 into a U-shape and a pair of extension portions 412 radially extending between both end portions of the U-shaped portion 411 and the supported portions 41b. Likewise, the connecting portion 42a integrally has a U-shaped portion 421 formed by bending the center conductor 400 into a U-shape and a pair of extension portions 422 radially extending between both end portions of the U-shaped portion 421 and the supported portions 42b. In the same way, the connecting portion 43a integrally has a U-shaped portion 431 formed by bending the center conductor 400 into a U-shape and a pair of extension portions 432 radially extending between both end portions of the U-shaped portion 431 and the supported portions 43b.

In such a configuration, the first bus ring 41 and the U-phase windings 32U are electrically connected at the connecting portions 41a in a state that the end portions 321U of the windings 32U are inserted into the U-shaped portions 411. Likewise, the second and third bus rings 42 and 43 and the V- and W-phase windings 32V and 32W are electrically connected respectively at the connecting portions 42a and 43a in a state that the end portions 321V and 321W of the windings 32V and 32W are inserted into the U-shaped portions 421 and 431.

The U-shaped portion 411 of the first bus ring 41 is composed of an arc portion 411a having an arc shape and a pair of shaft portions 411b, 411c which face each other in the circumferential direction with the arc portion 411a in-between and extend in the axial direction. Likewise, the U-shaped portion 421 of the second bus ring 42 is composed of an arc portion 421a having an arc shape and a pair of shaft portions 421b, 421c which face each other in the circumferential direction with the arc portion 421a in-between and extend in the axial direction. In the same way, the U-shaped portion 431 of the third bus ring 43 is composed of an arc portion 431a having an arc shape and a pair of shaft portions 431b, 431c which face each other in the circumferential direction with the arc portion 431a in-between and extend in the axial direction.

Arc-shaped protrusions 411d and 411e are formed respectively on the opposing portions of the paired shaft portions 411b and 411c of the first bus ring 41 so as to have a curvature which is larger than that of the outer peripheral surface of the center conductor 400 at the supported portion 41b and at the extension portion 412. Surfaces of the paired shaft portions 411b and 411c opposite to the protrusions 411d and 411e are formed as flat side surfaces 411f and 411g which are orthogonal to the circumferential direction of the first bus ring 41.

As show in FIGS. 6B and 6C, arc-shaped protrusions 421d, 421e, 431d and 431e and flat side surfaces 421f, 421g, 431f and 431g are also formed on the pair of shaft portions 421b, 421c of the second bus ring 42 and the pair of shaft portions 431b, 431c of the third bus ring 43 in the same manner as the pair of shaft portions 411b, 411c of the first bus ring 41.

The shaft portions 411b and 411c of the U-shaped portion 411 of the first bus ring 41 are shorter than the shaft portions 421b and 421c of the U-shaped portion 421 of the second bus ring 42, and the shaft portions 431b and 431c of the U-shaped portion 431 of the third bus ring 43 are longer than the shaft portions 421b and 421c of the U-shaped portion 421 of the second bus ring 42. This absorbs a difference of axial positions of the first to third bus rings 41 to 43 and end portions of the windings 32 on one side (the end portions 321U, 321V and 321W) are thus inserted into the U-shaped portions 411, 421 and 431 in the vicinity of the arc portions 411a, 421a and 431a.

### Configuration of Fixing Member 5

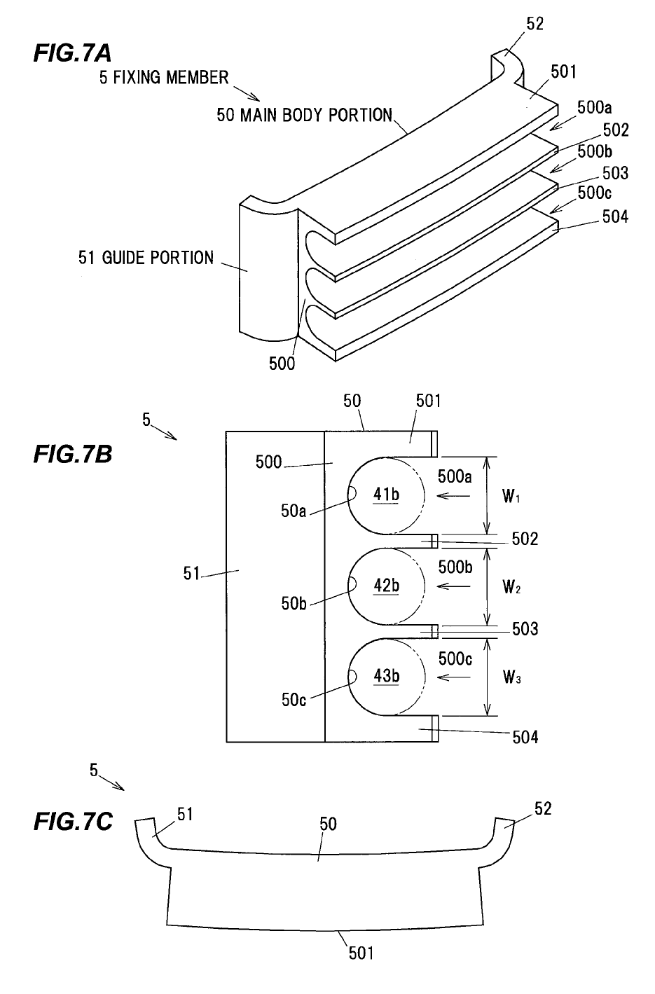

FIG. 7A is a perspective view showing an appearance of the fixing member 5, FIG. 7B is a side view showing the fixing member 5 and FIG. 7C is a top view showing the fixing member 5.

Each fixing member 5 has a main body portion 50 and guide portions 51, 52 formed at both circumferential ends of the main body portion 50. First to third recessed portions 500a, 500b and 500c which can partially house the first to third bus rings 41 to 43 are formed on the main body portion 50.

The main body portion 50 is slightly curved along the circumferential direction so as to match the circumferential curvature of the supported portions 41b, 42b and 43b of the first to third bus rings 41 to 43.

The main body portion 50 has a plate-like base portion 500 having a predetermined thickness in the radial direction, and an upper wall 501, a first middle wall 502, a second middle wall 503 and a lower wall 504 which are formed in a row along the axial direction so as to radially protrude from the base portion 500. The first recessed portion 500a is formed between the upper wall 501 and the first middle wall 502, the second recessed portion 500b is formed between the first middle wall 502 and the second middle wall 503 and the third recessed portion 500c is formed between the second middle wall 503 and the lower wall 504.

The first to third recessed portions 500a, 500b and 500c are formed to extend along the circumferential direction and open in the radial direction. In the first embodiment, the first to third recessed portions 500a, 500b and 500c are formed to be recessed radially inward and to open radially outward. In addition, bottom surfaces 50a, 50b and 50c of the first to third recessed portions 500a, 500b and 500c are formed in an arc shape which matches the curvature of the outer peripheral surfaces of the first to third bus rings 41 to 43 (see FIG. 2).

The guide portions 51 and 52 are formed respectively at both circumferential ends of the main body portion 50 so as to extend continuously from the bottom surfaces 50a, 50b and 50c of the first to third recessed portions 500a, 500b and 500c toward the inside in the radial direction. A pair of guide portions 51, 52 is formed so that outer surfaces continuous from the bottom surfaces 50a, 50b and 50c of the first to third recessed portions 500a, 500b and 500c are gently curved and a circumferential distance between the guide portions 51 and 52 increases toward the winding 32 (shown in FIG. 3) which are located radially inward.

As shown in FIG. 7B, the supported portion 41b is held in the first recessed portion 500a and the first bus ring 41 is thereby fixed to the fixing member 5. The supported portion 42b is held in the second recessed portion 500b and the second bus ring 42 is thereby fixed to the fixing member 5. Also, the supported portion 43b is held in the third recessed portion 500c and the third bus ring 43 is thereby fixed to the fixing member 5.

An opening width W₁ of the first recessed portion 500a is smaller than the diameter of the supported portion 41b of the first bus ring 41. Likewise, an opening width W₂ of the second recessed portion 500b and an opening width W₃ of the third recessed portion 500c are smaller than the diameters of the supported portions 42b and 43b of the second and third bus rings 42 and 43. Thus, the supported portions 41b, 42b and 43b of the first to third bus rings 41 to 43 are compressively deformed in the axial direction and press-fitted.

Here, press-fitting is to compress the first to third bus rings 41 to 43 toward the bottom surfaces 50a, 50b and 50c of the first to third recessed portions 500a, 500b and 500c. In more detail, it is compression by a force with which the first to third bus rings 41 to 43 compressed into the first to third recessed portions 500a, 500b and 500c do not easily fall out of the first to third recessed portions 500a, 500b and 500c (e.g., do not fall out due to own weight of the first to third bus rings 41 to 43).

As shown in FIGS. 3 and 4, plural fixing members 5 are attached to the first to third bus rings 41 to 43 at intervals along the circumferential direction, and pairs of extension portions 412, 422 and 432 of the first to third bus rings 41 to 43 are arranged between pairs of fixing members 5 adjacent in the circumferential direction of the first to third bus rings 41 to 43 so as to protrude in a direction of inserting the supported portions 41b, 42b and 43b into the first to third recessed portions 500a, 500b and 500c.

In the first embodiment, since the supported portions 41b, 42b and 43b of the first to third bus rings 41 to 43 are inserted into the first to third recessed portions 500a, 500b and 500c in a radially inward direction, the connecting portions 41a, 42a and 43a are arranged to protrude inward toward the windings 32 between the pairs of adjacent fixing members 5. Thus, when the electricity collection and distribution ring 4 is attached to the stator 3, the U-shaped portions 411, 421 and 431 are positioned at locations of the end portions 321U, 321V and 321W of the windings 32U, 32V and 32W.

Meanwhile, a distance between a pair of circumferentially adjacent fixing members 5 is a distance corresponding to a circumferential width of a pair of connecting portions 41a of the first bus ring 41, a circumferential width of a pair of connecting portions 42a of the second bus ring 42 and a circumferential width of a pair of connecting portions 43a of the third bus ring 43. Here, “a corresponding distance” means to have a dimensional relationship which causes the pairs of extension portions 412, 422 and 432 to come into contact with the guide portions 51 and 52 of the fixing members 5 when fixing the first to third bus rings 41 to 43 to each other using the fixing members 5 and allows the pairs of connecting portions 41a, 42a and 43a to be arranged at equal intervals in the circumferential direction. In addition, this restricts relative movement of the first to third bus rings 41 to 43 in the circumferential direction.

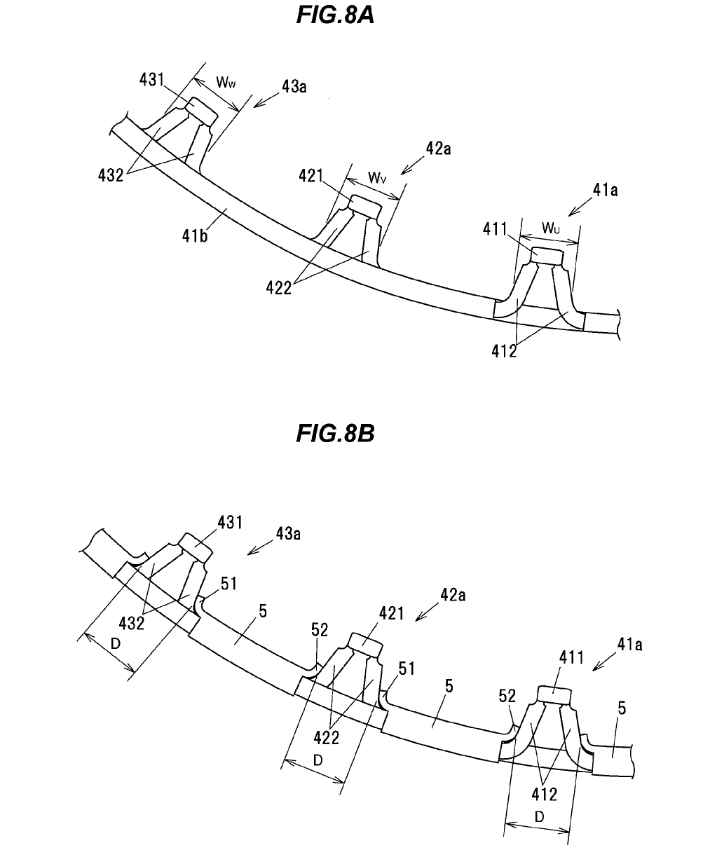

FIG. 8A is a plan view showing a portion of the electricity collection and distribution ring 4 as viewed from the axial direction. In the first embodiment, a circumferential width W_{U} between a pair of extension portions 412 of the first bus ring 41, a circumferential width W_{V} between a pair of extension portions 422 of the second bus ring 42 and a circumferential width W_{W} between a pair of extension portions 432 of the third bus ring 43 are the same width. The widths W_{U}, W_{V} and W_{W} shown in FIG. 8A are circumferential widths between middle portions of the extension portions 412, 422 and 432.

FIG. 8B is a plan view showing a state in which the fixing members 5 are attached to the first to third bus rings 41 to 43 of FIG. 8A. A distance D between a pair of fixing members 5 adjacent in the circumferential direction of the first to third bus rings 41 to 43 (a distance between the guide portion 52 of one of the pair of fixing members 5 and the guide portion 51 of the other fixing member 5) is slightly larger than the widths W_{U}, W_{V} and W_{W}. The distance D is, e.g., not less than 1.01 and not more than 1.1 times the widths W_{U}, W_{V} and W_{W}. The distance D shown in FIG. 8B is a distance between portions of the fixing members 5 facing the middle portions of the extension portions 412, 422 or 432 shown in FIG. 8A.

### Functions and Effects of the First Embodiment

The following functions and effects are obtained in the first embodiment.

(1) Since the first to third bus rings 41 to 43 respectively have the connecting portions 41a, 42a and 43a, holding rigidity of the fixing member 5 can be increased as compared to the case where the first to third bus rings 41 to 43 are fixed to each other by, e.g., holding members having attachment grooves for attaching junction terminals, and it is thus possible to increase rigidity of the electricity collection and distribution ring 4.

(2) The fixing members 5, which are the same single type and thus have the same shape, are used to fix the first to third bus rings 41 to 43. Therefore, it is possible to mold the fixing members 5 by one set of molds and the number of types of components can be also reduced, which allows the manufacturing cost of the electricity collection and distribution ring 4 to be reduced.

(3) Since the supported portions 41b, 42b and 43b of the first to third bus rings 41 to 43 are inserted into the first to third recessed portions 500a, 500b and 500c by press fitting, the fixing members 5 once fixed are less likely to be detached from the first to third bus rings 41 to 43 and this makes assembly easy.

(4) Each of the first to third bus rings 41 to 43 is formed by bending one insulated wire to have the U-shaped portions 411, 421, 431, the extension portions 412, 422, 432 and the supported portions 41b, 42b, 43b, and the end portions 321U, 321V and 321W of the U-, V- and W-phase windings 32U, 32V and 32W are electrically connected to the first to third bus rings 41 to 43 in a state of being inserted into the U-shaped portions 411, 421 and 431. Therefore, it is not necessary to use, e.g., connecting terminals to connect the first to third bus rings 41 to 43 to the U-, V- and W-phase windings 32U, 32V and 32W and this allows production efficiency to be improved and the manufacturing cost of the electricity collection and distribution ring 4 to be reduced.

(5) The first to third bus rings 41 to 43 are fixed to the fixing members 5 at intervals along the circumferential direction. This allows the connecting portions 41a, 42a and 43a to protrude radially inward from between the pairs of circumferentially adjacent fixing members 5 and thus to be easily connected the end portions 321U, 321V and 321W of the windings 32U, 32V and 32W.

(6) Since the distance between the fixing members 5 adjacent in the circumferential direction of the first to third bus rings 41 to 43 corresponds to the circumferential width between the pair of extension portions 412, 422, 432 of the first to third bus rings 41 to 43, the connecting portions 41a, 42a and 43a are arranged at equal distances when using the fixing members 5 to fix the first to third bus rings 41 to 43 to each other. This allows the U-shaped portions 411, 421 and 431 to be positioned at locations of the end portions 321U, 321V and 321W of the windings 32U, 32V and 32W when assembling the electricity collection and distribution ring 4 to the stator 3.

### Second Embodiment

Next, the second embodiment of the invention will be described.

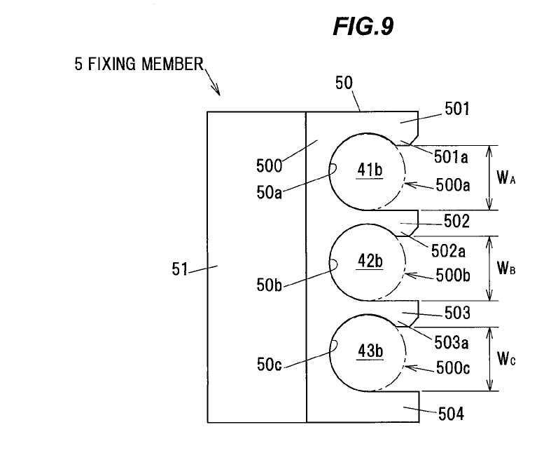

FIG. 9 is a side view showing the fixing member 5 in the second embodiment. The fixing member 5 in the second embodiment is the same as the fixing member 5 in the first embodiment except the shape. Therefore, the same constituent elements as those described in the first embodiment are denoted by the same reference numerals as those used in the first embodiment and the overlapped explanation thereof will be omitted.

In the second embodiment, locking portions 501a, 502a and 503a for locking the first to third bus rings 41 to 43 are provided on the main body portion 50 of the fixing member 5 to prevent the first to third bus rings 41 to 43 from falling out of the first to third recessed portions 500a, 500b and 500c.

The first recessed portion 500a for fixing the supported portion 41b (indicated by a dashed-two dotted line in FIG. 9) of the first bus ring 41 is formed between the upper wall 501 and the first middle wall 502 and the locking portion 501a is formed to protrude from a front end portion of the upper wall 501 toward the first middle wall 502.

Meanwhile, the second recessed portion 500b for fixing the supported portion 42b (indicated by a dashed-two dotted line in FIG. 9) of the second bus ring 42 is formed between the first middle wall 502 and the second middle wall 503 and the locking portion 502a is formed to protrude from a front end portion of the first middle wall 502 toward the second middle wall 503.

Furthermore, the third recessed portion 500c for fixing the supported portion 43b (indicated by a dashed-two dotted line in FIG. 9) of the third bus ring 43 is formed between the second middle wall 503 and the lower wall 504 and the locking portion 503a is formed to protrude from a front end portion of the second middle wall 503 toward the lower wall 504.

An opening width W_{A} (a distance between the locking portion 501a and the first middle wall 502) of the first recessed portion 500a is smaller than the diameter of the supported portion 41b of the first bus ring 41. Likewise, an opening width W_{B} (a distance between the locking portion 502a and the second middle wall 503) of the second recessed portion 500b and an opening width W_{C} (a distance between the locking portion 503a and the lower wall 504) of the third recessed portion 500c are smaller than the diameters of the supported portions 42b and 43b of the second and third bus rings 42 and 43. Thus, the first to third bus rings 41 to 43 are inserted into the first to third recessed portions 500a, 500b and 500c of the fixing member 5 by press-fitting while elastically deforming the upper wall 501, the first middle wall 502 and the second middle wall 503.

In the second embodiment, the locking portions 501a, 502a and 503a prevent the first to third bus rings 41 to 43 from falling out of the first to third recessed portions 500a, 500b and 500c more reliably than the first embodiment.

### Third Embodiment

Next, the third embodiment of the invention will be described.

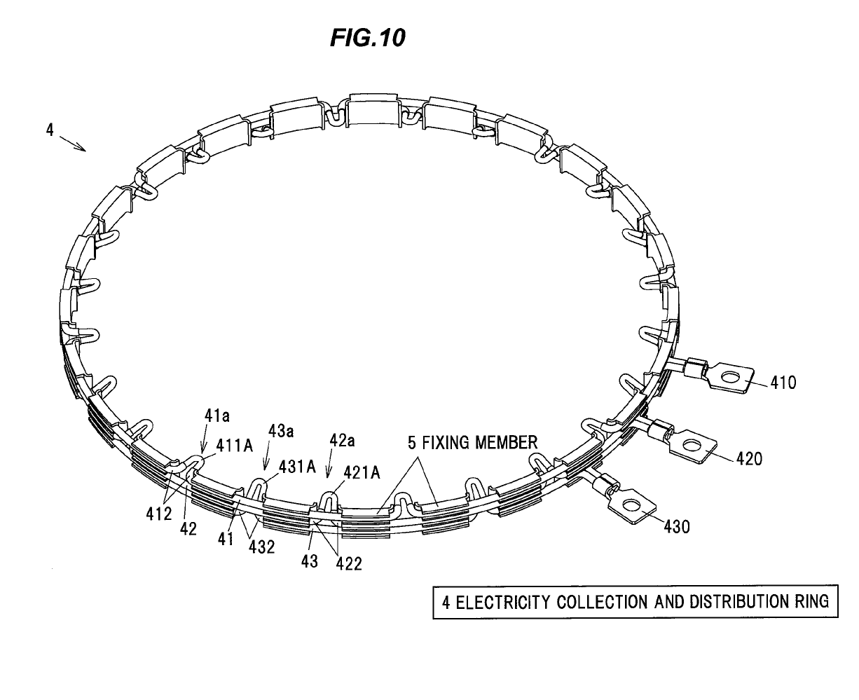

FIG. 10 is a perspective view showing a configuration example of the electricity collection and distribution ring 4 in the third embodiment. The electricity collection and distribution ring 4 in the third embodiment is the same as the first embodiment except the shapes of the connecting portions 41a, 42a and 43a of the first to third bus rings 41 to 43. Therefore, the same constituent elements as those described in the first embodiment are denoted by the same reference numerals as those used in the first embodiment and the overlapped explanation thereof will be omitted.

The connecting portion 41a of the first bus ring 41 integrally has a U-shaped portion 411A protruding radially inward of the first bus ring 41 and the extension portions 412. That is, a protruding direction of the U-shaped portion 411A of the connecting portion 41a in the third embodiment is different from that of the U-shaped portion 411 in the first embodiment.

Likewise, the connecting portions 42a and 43a of the second and third bus rings 42 and 43 respectively integrally have U-shaped portions 421A, 431A protruding radially inward of the second and third bus rings 42 and 43 and the extension portions 422, 432.

The U-shaped portion 421A of the second bus ring 42 is inclined in the axial direction so that the axial position of the tip end portion thereof is arranged at the same level as the position of the tip end portion of the U-shaped portion 411A of the first bus ring 41. Likewise, the U-shaped portion 431A of the third bus ring 43 is inclined in the axial direction so that the axial position of the tip end portion thereof is arranged at the same level as the position of the tip end portion of the U-shaped portion 411A of the first bus ring 41.

This absorbs a difference of axial positions of the first to third bus rings 41 to 43 and the end portions 321U, 321V and 321W (shown in FIG. 3) of the windings 32 (shown in FIG. 3) are thus inserted into the U-shaped portions 411A, 421A and 431A when the electricity collection and distribution ring 4 is attached to the stator 3.

In the third embodiment described above, it is possible to obtain the same functions and effects as the first embodiment. In addition, the first to third bus rings 41 to 43 can be made differently only by changing an inclination angle of the U-shaped portions 421A and 431A.

Although the embodiments of the invention have been described above, the invention according to claims is not to be limited to the embodiments. Further, all combinations of the features described in the embodiments are not always needed to solve the problem of the invention.

For example, the first to third bus rings 41 to 43 may be fixed such that the connecting portions 41a, 42a and 43a of the first to third bus rings 41 to 43 protrude radially outward from between the pairs of circumferentially adjacent fixing members 5 and the supported portions 41b, 42b and 43b of the first to third bus rings 41 to 43 are inserted into the first to third recessed portions 500a, 500b and 500c toward the outside in the radial direction.

### SUMMARY OF THE EMBODIMENTS

Technical ideas understood from the embodiments will be described below citing the reference numerals, etc., used for the embodiments. However, each reference numeral described below is not intended to limit the constituent elements in the claims to the members, etc., specifically described in the embodiments.

[1] An electricity collection and distribution ring (4) for collecting and distributing electricity from/to multi-phase windings (32) respectively wound around a plurality of annularly-arranged cores (31), comprising: a plurality of annular conductors (41 to 43) respectively connected to the multi-phase windings (32) according to the phases of electric current; and a plurality of fixing members (5) for fixing the plurality of annular conductors (41 to 43) to each other, wherein the annular conductor (41, 42, 43) comprises a plurality of connecting portions (41a, 42a, 43a) connected to end portions of the windings (32) at a plurality of positions in a circumferential direction, and the plurality of fixing members (5) are arranged between pairs of the connecting portions (41a, 42a, 43a) adjacent along a circumferential direction of the plurality of annular conductors (41 to 43).

[2] The electricity collection and distribution ring (4) described in the [1], wherein the fixing member (5) comprises a plurality of recessed portions (500a, 500b and 500c) for respectively housing portions of the plurality of annular conductors (41 to 43), and supported portions (41b, 42b and 43b) of the plurality of annular conductors (41 to 43) to be held by the fixing member (5) are inserted into the recessed portions (500a, 500b and 500c) by press-fitting.

[3] The electricity collection and distribution ring (4) described in the [1] or [2], wherein locking portions (501a, 502a and 503a) are provided on the fixing member (5) to lock the plurality of annular conductors (41 to 43) and thus to prevent the annular conductors (41 to 43) from falling out of the recessed portions (500a, 500b and 500c).

[4] The electricity collection and distribution ring described in any of the [1] to [3], wherein the connecting portion (41a, 42a, 43a) integrally comprises a U-shaped portion (411, 421, 431) formed by bending into a U-shape and extension portions (412, 422, 432) radially extending between both end portions of the U-shaped portion (411, 421, 431) and the supported portions (41b, 42b, 43b) to be held by the fixing member (5), and the annular conductors (41 to 43) are electrically connected to the windings (32) in a state that the end portions of the windings (32) are inserted into the U-shaped portions (411, 421, 431).

[5] The electricity collection and distribution ring described in any of the [1] to [4], wherein the plurality of recessed portions (500a, 500b and 500c) are aligned in an axial direction of the annular conductor (41, 42, 43) and open in a radial direction of the annular conductor (41, 42, 43), and the connecting portions (41a, 42a, 43a) of the plurality of annular conductors (41 to 43) protrude from between pairs of the adjacent fixing members (5) in a direction of inserting the supported portions (41b, 42b and 43b) into the recessed portions (500a, 500b and 500c).

[6] The electricity collection and distribution ring described in the [5], wherein a distance between a pair of the fixing members (5) adjacent in a circumferential direction of the plurality of annular conductors (41 to 43) corresponds to a distance between a pair of the extension portions (412, 422, 432).

What is claimed is:

1. An electricity collection and distribution ring for collecting and distributing electricity from/to multi-phase windings, comprising:
a plurality of annular conductors respectively connected to the multi-phase windings according to the phases of electric current; and
a plurality of fixing members for fixing the plurality of annular conductors to each other,
wherein the annular conductor comprises a plurality of connecting portions connected to end portions of the windings at a plurality of positions in a circumferential direction, and
wherein the plurality of fixing members are disposed between a pair of the plurality of connecting portions adjacent along a circumferential direction of the plurality of annular conductors.

2. The electricity collection and distribution ring according to claim 1, wherein the fixing members each comprise a plurality of recessed portions for housing a portion of the plurality of annular conductors, and
wherein the plurality of annular conductors each comprise a supported portion being held by the fixing members and inserted into the recessed portions by press-fitting.

3. The electricity collection and distribution ring according to claim 2, wherein the fixing members each comprise a locking portion to lock the plurality of annular conductors so as to prevent the annular conductors from falling out of the recessed portions.

4. The electricity collection and distribution ring according to claim 2, wherein the connecting portions comprise integrally a U-shaped portion formed by bending into a U-shape and an extension portion radially extending between both end portions of the U-shaped portion and the supported portion, and
wherein the annular conductors are electrically connected to the windings while an end portion of the windings is inserted into the U-shaped portion.

5. The electricity collection and distribution ring according to claim 2, wherein the plurality of recessed portions are aligned along an axis of the annular conductors and opened in a radial direction of the annular conductors, and
wherein the connecting portions of the plurality of annular conductors protrude between a pair of the adjacent ones of the fixing members in a direction of inserting the supported portion into the recessed portions.

6. The electricity collection and distribution ring according to claim 4, wherein a distance between a pair of adjacent ones of the fixing members in a circumferential direction of the plurality of annular conductors corresponds to a distance between a pair of the extension portion.
